(19) United States
(12) Patent Application Publication
(10) Pub. No.: US 2015/0165817 A1
(43) Pub. Date: Jun. 18, 2015

(54) INSPECTION WINDOW FOR CANS AND CAN COMPRISING SUCH INSPECTION WINDOW

(71) Applicant: Brasilata S/A Embalagens Metálicas, São Paulo-SP (BR)

(72) Inventors: Antonio Carlos Teixeira Alvares, Sao Paulo-SP (BR); Antonio Roberto Sene, Sao Paulo-SP (BR)

(73) Assignee: Brasilata S/A Embalagens Metalicas, Sao Paulo-SP (BR)

(21) Appl. No.: 14/401,748

(22) PCT Filed: May 16, 2013
(86) PCT No.: PCT/BR2013/000170

§ 371 Date: Nov. 17, 2014

(30) Foreign Application Priority Data
May 16, 2012 (BR) 10 2012 011648 0

(51) Int. Cl. B44D 3/12; B65D 51/24; B65D 43/02; B65D 6/00; B65D 25/54

(52) U.S. Cl. CPC B44D 3/127; B65D 7/12; B65D 25/54; B65D 43/021; B65D 51/245

(57) ABSTRACT

The present invention is applied to cans presenting a tubular body (10), inferiorly closed by a bottom wall (12) and superiorly closed by any of the parts defined by a removable lid (20), or by a set formed by an annular upper wall (16) and by a lid (20) which is seated on a seat defined in the annular upper wall (16). The inspection window comprises: a seat (40) provided in any of the parts defined by the lid (20), annular upper wall (16), and lateral wall (11) of the tubular body (10), said seat (40) presenting an outer annular surface (41) and an inner annular surface (42); and a plug (50) of transparent polymeric material, permanently fitted on the seat (40) and presenting a median panel portion (51) incorporating a peripheral upper flange (52), seated onto the outer annular surface (41) of the seat (40), and a peripheral lower ridge (53) tightly seated against the inner annular surface (43) of the seat (40).

### FIELD OF THE INVENTION

The present invention refers to an improvement to be applied in cans, in order to allow the visual inspection of their contents, preventing said contents from being exposed to contact to the outer environment, without impairing the tightness and resistance of these cans in holding the stored product. The invention is applied in cans formed in metallic sheet and which comprise a tubular body portion of polygonal or circular cross section, being inferiorly closed by a bottom wall and superiorly having a seat surrounding an upper opening in which is usually fitted a removable upper lid.

### BACKGROUND OF THE INVENTION

There are well known from the prior art the tubular cans made of metallic sheet and comprising a body portion, having a circular or polygonal cross section and carrying a bottom wall which is peripherally fixed, usually by a double seam, to the lower end edge of a lateral wall of the can. These cans may incorporate an annular upper wall, double seamed to the upper edge of the lateral wall of the can and defining the seat onto which the lid is seated, or may be deprived of said annular upper wall, in which case the lid is peripherally seated and retained on an outer peripheral curl formed by bending the upper end edge of the lateral wall of the can.

In the retail of paints and other products, it is becoming more frequent the adoption of cans having an auxiliary inspection lid which allows the user to verify the color of the product filled in the can, usually when this color is obtained by means of a manual or mechanized mixture of pigments or other additives calculated to impart, to the basic load contained in the can, the color or other visually detectable characteristic.

Among the known solutions for inspection of the contents inside the can, the upper wall, if present, or the main upper lid, is provided with an auxiliary inspection lid, which is removable in order to allow the introduction of pigments or other additives to the basic contents inside the can, without the need for removing the upper lid, as well as the visual inspection of the contents of the can, even after the auxiliary lid has been taken to the closed position, as may be seen in documents U.S. Pat. No. 3,572,340, U.S. Pat. No. 6,675,983.

Although the constructions having a removable auxiliary lid allow the visualization of the contents of the can and the access thereto, such removable auxiliary inspection—lid presents the drawback of allowing their removal by a simple manual operation, thus making the contents of the can vulnerable to undesired violations and potentially disastrous, both for the retailer and for the final user.

In the cases in which there is no need for opening the can, such as when the stored product does not need to be colored or additivated after its filling by the product manufacturer, such kind of removable auxiliary lid is not provided since, due to its construction and to the characteristics of their seats to be formed in a respective opening of the upper wall of the can, if present, or of the main upper lid, cause an undesirable increase in the production costs of said cans.

However, the absence of a transparent inspection window in these cans prevent the identification of the color or of another visual characteristic of. the filled product to be carried out or checked by a simple visual inspection of the contents of the can, without exposing the latter to the outer environment. In this common situation, the identification of the characteristics of the filled product is carried out exclusively by means of a label or printing applied to the exterior of the can, usually in a lower region of the lateral wall thereof, without offering the possibility to the end user to check the product being acquired without opening the main lid of the can, thus making evident the violation of the contents and its exposition to the atmosphere. This present reality also does not allow the user to check, without opening the single main lid, whether the filled product effectively corresponds to the information provided in the outer label.

### SUMMARY OF THE INVENTION

Due to the limitations of the known constructions of removable lid for inspection of the contents of cans, the present invention has, as the main object, to provide a inspection window which is transparent, of simple construction and of relatively low cost, to be fixed, in a secure and permanent manner, to a wall or to the upper lid of the can, in order to make evident the violation of the contents of the can in case it is removed.

It is a further object of the invention to provide a can in metallic sheet, presenting an inspection window as mentioned above.

The above objective is achieved by the provision of an inspection window for cans of the type presenting a tubular body, inferiorly closed by a bottom wall and superiorly closed by any of the parts defined by a removable superior lid, seated on the upper edge of the tubular body, and by a set formed by an annular upper wall and by a removable upper lid, which is seated on a seat defined in said annular upper wall.

The inspection window of the present invention comprises: a seat provided in any of the parts defined by lid, annular upper wall and lateral wall of the tubular body, said seat presenting an outer annular surface facing outwards of the can and an inner annular surface facing inwards of the can; and a plug of transparent polymeric material fitted in a permanent manner in the seat and having a median panel portion peripherally incorporating, a peripheral upper flange, seated on the outer annular surface of the seat, and a peripheral lower rib tightly seated against the inner annular surface of the seat.

This construction allows providing the can with an inspection window, of simple construction and relatively low cost, fixed to a wall or to the upper lid of the can, in order to make evident the violation of the contents of the can, in case it is removed.

### BRIEF DESCRIPTION OF THE DRAWINGS

The invention will be described below, with reference to the enclosed drawings, given by way of example of a possible embodiment of the invention, and in which:

FIG. 1 represents a top plan view of a possible can construction, in the condition closed by a lid, in which is formed the inspection window of the present invention;

FIG. 1A represents a view similar to that of FIG. 1, however illustrating the inspection window provided in the annular upper wall of a polygonal can;

FIG. 2 represents a diametral longitudinal cross section view of the can illustrated in FIG. 1, said cut being taken according to line II-II in said previous figure and with the lid in the closed position and locked by a retention ring;

FIG. 3 represents an enlarged detail of an upper part of the can of FIG. 2, illustrating the region for seating and retaining the lid in the can;

FIG. 4 represents a diametral perpendicular cross section view of the inspection window provided on the lid of the can; and

FIG. 5 represents an enlarged detail of the region of FIG. 4, which defines the assembly and retention of the inspection window on the lid.

### DESCRIPTION OF THE INVENTION

The present invention will be described considering a can for filling products of the type built in metallic sheet, particularly, however not specifically and restrictively of the type used for the filling of paints, varnishes and the like.

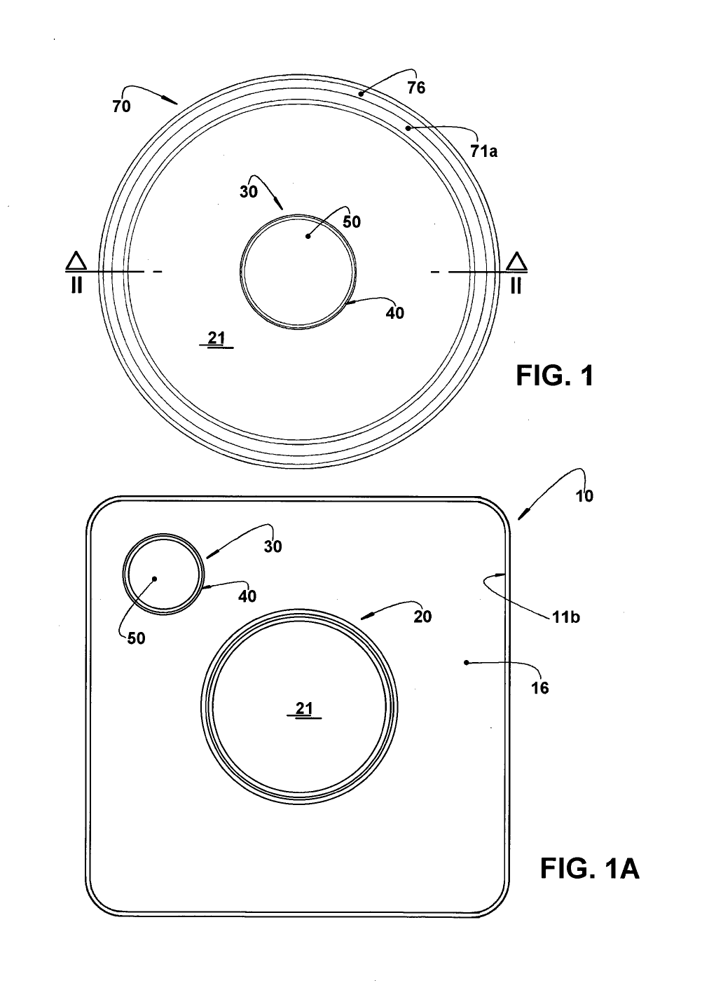

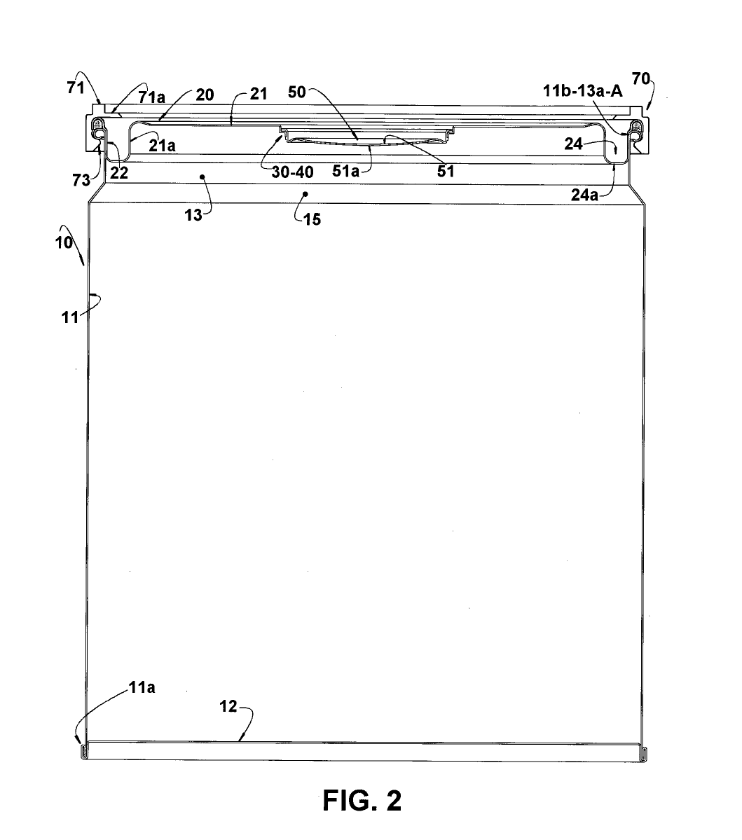

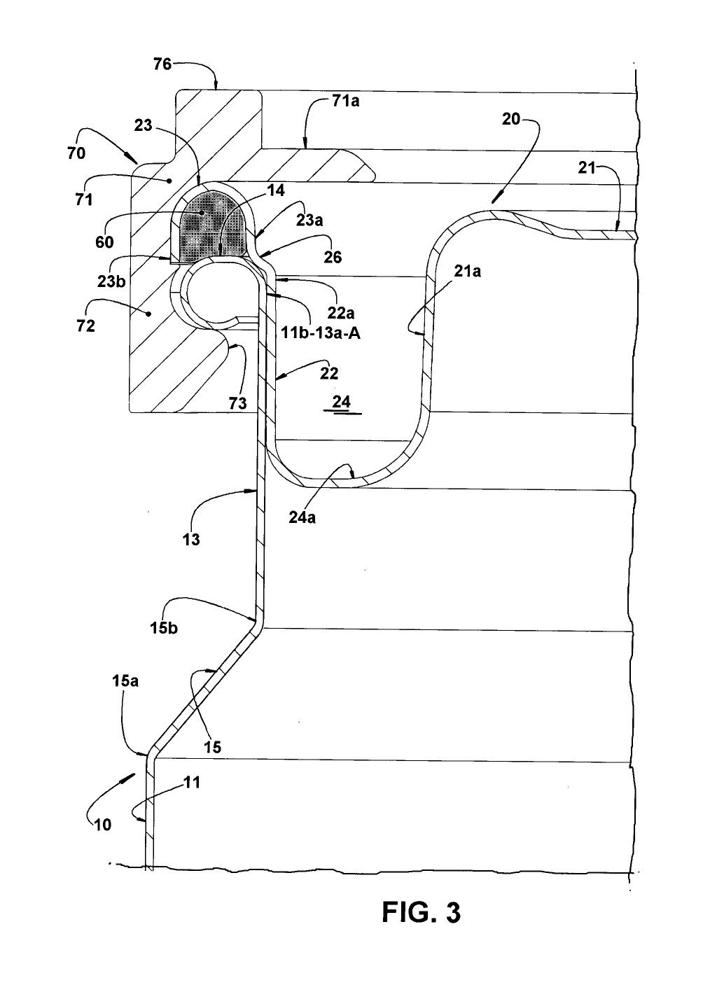

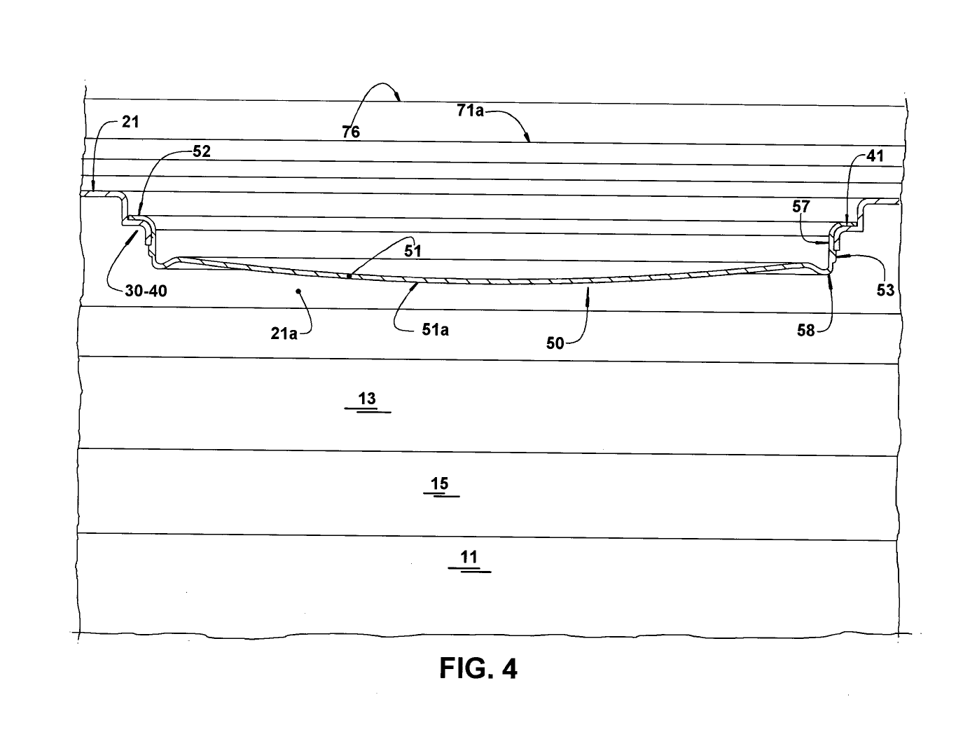

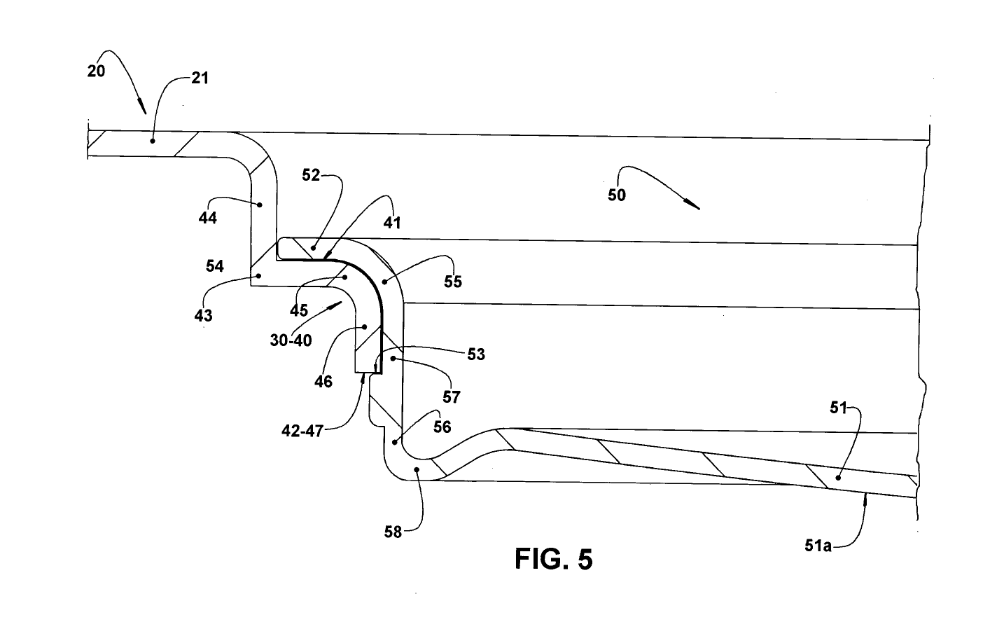

According to FIGS. 1, 2 and 3 of the drawings, the can presents a tubular body 10 having a lateral wall 11 defining a lower edge 11a and an upper edge 13a, with the tubular body 10 being inferiorly closed by a bottom wall 12 which is fixed, usually by double seaming, to the lower edge 11a of the lateral wall 11, and superiorly closed by a lid 20, which is superior and removable, seated on the upper edge 13a of the tubular body 10. As illustrated in FIG. 1A, the can may present a rectangular contour, being superiorly closed by a set formed by an annular upper wall 16, peripherally double seamed to an upper edge 11b of the lateral wall 11 of the tubular body 10, and by a lid 20 seated on a seat defined in said annular upper wall 16.

In a few can constructions, for example those for containing paint, varnish and the like, to the upper edge 11b of the lateral wall 11 is fixed, usually by double seaming, an annular upper wall, which may take the form of a structural ring, not illustrated, or of an annular plate in bigger cans, such the one for 18 liters having a square polygonal contour, illustrated in FIG. 1A. In these constructions, the annular upper wall presents a seat for seating, superiorly and in a removable manner, the lid 20.

In both constructions, the can is provided with a discharge opening A which defines a seat for seating and retaining the lid 20.

In can constructions such as that illustrated herein in FIGS. 1, 2 and 3, the lateral wall 11 of the body presents a neck portion 13, having a contour reduced in relation to the remaining of the lateral wall 11 of the can 10, the upper edge 11b of the lateral wall 11 matching the upper edge 13a of the neck portion 13 of the lateral wall 11. Said upper edge 13a incorporates an outer peripheral rib 14 and defines the contour of the upper opening A, against which is seated the lid 20.

In this construction of lid and can illustrated in the drawings, the lateral wall 11 also presents a transition portion 15 of diametral reduction of the lateral wall 11 between the lower edge 11a thereof and the neck portion 13.

The illustrated lid 20 has a panel portion 21, which incorporates a peripheral tubular portion 22 to be fitted with interference into the upper opening A, and has an upper edge 22a carrying an outer circumferential rib 23.

According to one aspect of the invention, it is provided at least one inspection window 30 comprising: a seat 40 provided in any of the parts defined by the lid 20, by the annular upper wall 16, and by the lateral wall 11 of the tubular body 10, said seat 40 presenting an outer annular surface 41 facing outwards of the can, and an inner annular surface 42, facing inwards of the can; and a plug 50 of transparent polymeric material which is permanently fitted in the seat 40 and presents the median panel portion 51 peripherally incorporating a peripheral upper flange 52, seated onto the outer annular surface 41 of the seat 40, and a peripheral lower ridge 53 tightly seated against the inner annular surface of the seat 40.

According to a way of carrying out the invention, the seat 40 is formed in a single piece in the same metallic material which forms the part of the can in which it is provided. In the illustrated embodiment, the seat 40 is defined in a single piece as an integral part of the lid 20.

According to the invention, the seat 40 is formed by bending the metallic sheet of any of the parts of lid 20, annular upper wall 16, and lateral wall 11 of the tubular body 10, in which said seat 40 is provided in a single piece. In the illustrated embodiment, the seat 40 presents the outer annular surface 41 thereof positioned in a lower plane in relation to the outer face of the lid 20, but it should be understood that said lower plane may also be provided if the seat 40 is provided on the annular upper wall 16, or on the lateral wall 11 of the tubular body 10.

The lowering of the outer annular surface 41 of the seat 40 in relation to the plane of the outer face in which said seat 40 is provided, is carried out in order to define a housing for the plug 50, avoiding damages to the latter, for example, such as perforation or transparency loss from contact with another product or can on said plug 50.

In a particular constructive form, the lowering is calculated to have a depth corresponding to the thickness of the peripheral upper flange 52 of the plug 50, so that said peripheral upper flange 52 does not project above the outer surface of the part of the can in which the seat 40 is formed.

The outer annular surface 41 of the seat 40 has an outer peripheral edge 43, which is incorporated, by means of a tubular wall portion 44, to one of the parts of lid 20, annular upper wall 16, and lateral wall 11 of the tubular body 10, in which part said seat 40 is provided. Said outer annular surface 41 of the seat 40 also has an inner peripheral edge 45, from which the seat 40 incorporates a tubular projection 46 extending axially to the interior of the can and which presents a lower edge 47 defining the inner annular surface 42 of the seat 40.

According to the present invention, the peripheral upper flange 52 of the plug 50 presents an outer peripheral edge 54 seated against the tubular wall portion 44 of the seat 40 and an inner peripheral edge 55. This seating is carried out, in a tight manner or with a minimum clearance, by designing it in order to prevent the introduction of tools that may force the removal of said plug 50 from its seated condition on the seat 40.

In a way of carrying out the present invention, the clearances are smaller than, for example, 0.05 mm, said clearances being defined considering thermal expansion, adjustments, etc.

It should be understood that the plug 50 is hermetically seated on the seat 40, in order to prevent the product filled in the can from leaking to the outside of the latter through gaps or due to thermal expansion differences, for example.

According to the present invention, the median panel portion 51 of the plug 50 presents a peripheral edge 56, which is incorporated to the inner peripheral edge 55 of the peripheral upper flange 52 of the plug 50 by a tubular portion 57 tightly seated inside the tubular projection 46 of the seat 40, said tubular portion 57 externally incorporating the peripheral lower ridge 53.

The median panel portion of the plug 50 presents a lower face 51a, whose cross section defines a profile which extends, in a progressively descending manner, from the region of the peripheral edge 56 thereof to a central region of said median panel portion 51, in any radial direction. In the illustrated construction, a lower circumferential shoulder 58 for structural reinforcement of the median panel portion 51 is provided adjacent to the peripheral edge 56 of the median panel portion 51 and internally in relation to the first.

The central region defines a dripper for the liquid product which internally contacts the plug 50 of the inspection window 30, thus avoiding, upon removing the lid, sparse droplets of the product and also, in the closed lid condition, the accumulation of dried product on the inner face of the median panel portion 51, which may originate a film able to impair the visualization of the contents of the can through the inspection window. In the illustrated construction, said median panel portion 51 profile defines an inferiorly convex arc.

In the can 10 construction illustrated in FIGS. 1, 2 and 3, the neck portion 13 has a concentric contour, similar to and reduced in relation to that of the lateral wall 11, and an upper end edge 13a defining the contour of the opening “A” of the can 10. The transition portion 15 presents an inclined profile in relation to the axis of the can 10.

The upper end edge 13a of the neck portion 13 incorporates the outer peripheral rib 14 which, in the illustrated condition, takes the form of a curl having tubular cross section, obtained by bending the metallic sheet radially outwards in the region of the upper end edge 13a. In the drawings, the curl has a circular cross section, however it should be understood that a peripheral ridge may be formed having different cross sections, tubular or not.

The formation of the body 10 is started by forming a tubular body having a cross section corresponding to that of the neck portion 13, and which is then radially expanded, throughout part of its height, in order to define the remaining of the lateral wall 11 and of the transition portion 15, according to methods known in the art. The transition portion 15 remains inferiorly joined to the remaining of the lateral wall 11, by a convex arc junction region 15a, and superiorly joined to the neck portion 13, by a concave arc junction region 15b.

The lid 20 is formed in a single piece of stamped metallic sheet, presenting a panel portion 21 which occupies a substantial part of the cross section area of the upper opening “A” and incorporates a peripheral tubular portion 22 configured and dimensioned to be fitted in a tight manner and with interference, in the upper opening “A” inside the neck portion 13. Said peripheral tubular portion 22 presents an upper edge 22a in which is incorporated an outer circumferential rib 23, configured to be seated on the outer peripheral rib 14 on the upper end edge 13a of the neck portion 13.

Although the drawings illustrate an outer circumferential rib 23 shaped as an inferiorly open curl, it should be understood that other cross section shapes may be used, such as for example, an arc of a circle forming a semi-tubular profile.

As illustrated, the lid 20 is preferably built having the panel portion 21 thereof incorporating a pending skirt 21a which forms, with the peripheral tubular portion 22, a peripheral channel 24 having a rectangular cross section, radially separating the panel portion 21 from the peripheral tubular portion 22, the panel portion 21 being thus positioned in a plane elevated in relation to the bottom wall 24a of the peripheral channel 24.

According to the invention, the outer peripheral rib 23 presents a semi-tubular shape, inferiorly open and having: a radially inner edge 23a which is joined to the upper edge 22a of the peripheral tubular portion of the lid 20 by an um annular step 26 which projects outward from said peripheral tubular portion 22; and a radially outer edge 23b, spaced from the radially inner edge 23a, the outer peripheral rib 23 carrying, in its interior, an annular gasket 60, preferably in the form of a chord of resin, for example “Plastisol”, molded inside the outer peripheral rib 23 of the lid 20.

The annular gasket 60 is configured, inside the outer peripheral rib 23, to be seated and compressed onto the outer peripheral rib 14 of the neck portion 13, upon fitting the lid 20 in the upper opening A of the can and upon seating the annular step 26 onto the outer peripheral rib 14 of the neck portion 13.

According to the illustrated construction, the outer peripheral rib 23 has the projection of its radially inner edge 23a, in the axial direction of the can, defined secant to the radially innermost half of the contour of the outer peripheral rib 14 of the neck portion 13, and the projection, in the same axial direction of the radially outer edge 23b of the outer peripheral rib 23, being defined radially external to the contour of the outer peripheral rib 14 of the neck portion 13.

Still according to the illustrated construction, the radially inner edge 23a and the radially outer edge 23b of the outer peripheral rib 23 define, between each other, an alignment secant to the upper half of the contour of the outer peripheral rib 14 of the neck portion 13. This constructive form allows that, upon fitting the lid in the opening A of the can, the upper portion of the contour of the outer peripheral rib 14 slightly penetrates in the interior of the lower contour of the outer peripheral rib 23, thus compressing the annular gasket 30 and assuring a high level of tightness to the closure of the lid.

Aiming to provide a certain degree of interference between the annular gasket 30 and the upper portion of the outer peripheral rib 14, the annular gasket 60 is configured to be inferiorly tangent to or cut by the alignment defined by the radially inner edge 23a and radially outer edge 23b of the outer peripheral rib 23 of the lid 20.

As illustrated in the drawings, the present closure arrangement may further comprise a retention ring 70 in a single piece of plastic material and having: an upper annular portion 71 to be seated on the outer peripheral rib 23 of the lid 20; a peripheral skirt portion 72 pending from the upper annular portion 71, laterally and tightly surrounding the outer peripheral rib 23 of the lid 20 and the outer peripheral rib 14 of the neck portion 13 and incorporating an inner circumferential projection 73, to be seated and axially locked under the outer peripheral rib 14 of the neck portion 13.

In the illustrated embodiment, the inner circumferential projection 73 presents a profile in the form of a ramp inclined downwards and radially inwards, in order to define a tooth acting under the outer peripheral rib 14 of the neck 13, in order to provide a safe axial locking of the lid 20 to the body 10 of the can.

The retention ring 70 prevents the lid 20 from being removed without making evident the necessary use of a leverage tool, using as support the outer peripheral rib 14.

Although not illustrated herein, the retention ring 70 may have the upper annular portion 71 thereof internally incorporating the diametrically opposite ends of a suspension handle to be displaced from a retracted non-operational position, coplanar or substantially coplanar to the upper annular portion 71, to a raised operational position obtained after rupture of breakable connections which join a median portion of the handle to the upper annular portion of the lid.

In the illustrated embodiment, the retention ring 70 further incorporates, in the upper annular portion 71 thereof, an upper tubular projection 76 positioned and dimensioned to be fitted against the bottom wall 12, internally to its peripheral double seam, of another identical can nested on the first in a stack of said cans.

When the can contains paints, varnishes and similar products, the upper annular portion 71 of the retention ring 70 may be extended radially inwards, in relation to the position of the upper tubular projection 76, in order to form a tab 71a for scraping paint brushes when, after removing the lid 20, the retention ring 70 is re-conducted to its axially locked position under the outer peripheral rib 14 of the neck portion 13. In the cases in which the retention ring 70 is provided with a suspension handle, its fitting in the can without the lid allows the can to be suspended by the handle of the retention ring 70, while its contents is progressively removed in a continuous painting operation.

While only one embodiment of the present invention and of the application field thereof have been illustrated herein, it should be understood that changes can be made in the form and arrangement of the elements, without departing from the constructive concept defined in the claims that accompany the present disclosure.

It should be further noted that constructive variants of the inspection window 30 mentioned in the present disclosure may be provided in different lid or can body constructions, whereby the can illustrated in the attached drawings should not be considered limitative.

1. An inspection window for cans of the type which presents a tubular body (10), inferiorly closed by a bottom wall (12) and superiorly closed by any of the parts defined by a lid (20), which is superiorly removable and seated on the upper edge (13a) of the tubular body (10), and by a set formed by an annular upper wall (16) and by a lid (20) which is seated on a seat defined in said annular upper wall (16), comprising:
a seat (40) provided in any of the parts defined by the lid (20), annular upper wall (16), and lateral wall (11) of the tubular body (10), said seat (40) having an outer annular surface (41) facing outwards of the can and an inner annular surface (42) facing inwards of the can; and
a plug (50) of transparent polymeric material fixed in a permanent manner in the seat (40) and having a median panel portion (51) peripherally incorporating a peripheral upper flange (52), which is seated on the outer annular surface (41) of the seat (40), and a peripheral lower ridge (53) tightly seated against the inner annular surface (43) of the seat (40).

2. The inspection window of claim 1, wherein the seat (40) is formed by bending the metallic sheet of any of the parts of lid (20), annular upper wall (16) and lateral wall (11) of the tubular body (10), into which part said seat (40) is provided in a single piece.

3. The inspection window of claim 1, wherein the seat (40) presents the outer annular surface (41) thereof positioned in a lower plane in relation to the outer face of any of the parts of lid (20), annular upper wall (16), and lateral wall (11) of the tubular body (10), into which part said seat (40) is provided.

4. The inspection window of claim 1, wherein the outer annular surface (41) of the seat (40) has an outer peripheral edge (43) incorporated to one of the parts of lid (20), annular upper wall (16), and lateral wall (11) of the tubular body (10), into which part said seat (40) is provided by means of a tubular wall portion (44).

5. The inspection window of claim 1, wherein the peripheral upper flange (52) of the plug (50) presents an outer peripheral edge (54) seated against the tubular wall portion (44) of the seat (40).

6. The inspection window of claim 1, wherein the outer annular surface (41) of the seat (40) incorporates, in the inner peripheral edge (45) thereof, a tubular projection (46) which extends axially to the interior of the can and which presents a lower edge (47) defining the lower annular surface (42) of the seat (40).

7. The inspection window of claim 1, wherein the peripheral upper flange (52) of the plug (50) presents an inner peripheral edge (55), the median panel portion (51) of the plug (50) presenting a peripheral edge (56) which is incorporated to the inner peripheral edge (55) of the peripheral upper flange (52) by a tubular portion (57) tightly seated inside the tubular projection (46) of the seat (40), said tubular portion (57) externally incorporating the peripheral lower ridge (53).

8. The inspection window of claim 1, wherein the median panel portion (51) of the plug (50) presents a lower face (51a), which cross section defines a profile extending in a progressively descending manner, from a peripheral edge (56) of said median panel portion (51) to a central region of the latter, in any radial direction.

9. The inspection window of claim 8, wherein said profile defines an interiorly convex arc.

10. The inspection window of claim 1, wherein the can comprises: the tubular body (10) inferiorly closed; a neck portion (13), presenting a reduced contour and an upper end edge (13a), which incorporates an outer peripheral rib (14) and defines the contour of an upper opening (A); a transition portion (15) joining an adjacent portion of the lateral wall (11) and neck portion (13); and a lid (20) having a panel portion (21) which incorporates a peripheral tubular portion (22) to be fitted under interference into said upper opening (A) and having an upper edge (22a) carrying the outer circumferential rib (23), the outer circumferential rib (23) presenting a semi-tubular shape being inferiorly open and having: a radially inner edge (23a) which is joined to the upper edge (22a) of the peripheral tubular portion (22) of the lid (20), by an annular step (26) projecting outwards from said peripheral tubular portion (22); and a radially outer edge (23b), spaced from the radially inner edge (23a), the outer circumferential rib (23) carrying, in the interior thereof, an annular gasket (60) to be seated and compressed onto the outer peripheral rib (14) of the neck portion (13), upon the fitting of the lid (20) in the upper opening (A) and the seating of the annular step (26) onto the outer peripheral rib (14) of the neck portion (13).

11. The inspection window of claim 10, wherein the outer peripheral rib (14) and the outer circumferential rib (23) are defined by bending radially outwards the upper end edge (13a) of the neck portion (13) and the upper edge (22a) of the peripheral tubular portion (22) of the lid (20), respectively.

12. The inspection window of claim 11, further comprising a retention ring (70), in a single piece of plastic material and having: an upper annular portion (71) to be seated onto the circumferential rib (23) of the lid (20); a peripheral skirt portion (72) pending from the upper annular portion (71), laterally and tightly surrounding the outer circumferential rib (23) of the lid (20) and the outer peripheral rib (14) of the neck portion (13), and incorporating an inner circumferential projection (73), to be seated and axially locked under the outer peripheral rib (14) of the neck portion (13).

13. The inspection window of claim 12, wherein the retention ring (70) further incorporates, in the upper annular portion (71) thereof, an upper tubular projection (76) positioned and dimensioned to be fitted against the bottom wall (12), internally to the peripheral double seam of another identical can nested on the first in a stack of said cans.

14. A can of the type presenting a tubular body (10), inferiorly closed by a bottom wall (12) and superiorly closed by any of the parts defined by a lid (20), which is superior and removable, seated on the upper edge (lib, 13a) of the tubular body (10), and by a set formed by an annular upper wall (16) and by a lid (20) which is seated on a seat defined in said annular upper wall (16), wherein the can comprises at least one inspection window (30), such as defined in claim 1.
